(19) United States
(12) Patent Application Publication
(10) Pub. No.: US 2007/0126707 A1
(43) Pub. Date: Jun. 7, 2007

(54) Linearized touch sensor having protective coating

(76) Inventor: Terence A. Jones, Stillwater, MN (US)

Correspondence Address: 3M INNOVATIVE PROPERTIES COMPANY, PO BOX 33427, ST. PAUL, MN, 55133-3427, US

(21) Appl. No.: 11/293,723

(22) Filed: Dec. 2, 2005

(51) Int. Cl. G09G 5/00

(52) U.S. Cl. 345/173

(57) ABSTRACT

A touch sensor is disclosed. The sensor includes an electrically resistive layer that covers a touch sensitive area. The sensor further includes an electrically insulative layer that is disposed on the electrically resistive layer. The insulative layer has one or more open areas. Each open area exposes a portion of the resistive layer. The sensor also includes a plurality of electrically conductive segments that are disposed on the insulative layer. Each conductive segment makes electrical contact with the resistive layer through at least one of the open areas in the insulative layer. The conductive segments improve linearity of the touch sensitive area.

### FIELD OF THE INVENTION

This disclosure generally relates to linearized touch sensors, and is particularly applicable to linearized touch sensors having a protective coating that covers a touch sensitive area.

### BACKGROUND

Touch screens allow a user to conveniently interface with an electronic display system by reducing or eliminating the need for a keyboard. For example, a user can carry out a complicated sequence of instructions by simply touching the screen at a location identified by a pre-programmed icon. The on-screen menu may be changed by re-programming the supporting software according to the application. As another example, a touch screen may allow a user to transfer text or drawing to an electronic display device by directly writing or drawing onto the touch screen.

Resistive and capacitive are two common touch sensing methods employed to detect the location of a touch input. Resistive technology typically incorporates two transparent conductive films as part of an electronic circuit that detects the location of a touch. Capacitive technology, on the other hand, commonly uses a single transparent conductive film to detect the location of an applied touch. The transparent conductive film is often deposited on an insulating substrate and is covered with a thin dielectric coating to protect the conductive film from damage.

A touch location is generally determined by applying an electric field to a resistive film in the touch sensitive area. For an electrically continuous resistive film, the accuracy of detecting the location of an applied touch often depends on the linearity of the electric field in the resistive film. The electric field linearity is usually improved by forming an electrode pattern around the touch sensitive area.

### SUMMARY OF THE INVENTION

Generally, the present invention relates to touch sensors. In one embodiment of the invention, a touch sensor includes an electrically resistive layer that covers a touch sensitive area. The touch sensor further includes an electrically insulative layer that is disposed on the electrically resistive layer. The insulative layer has one or more open areas. Each open area exposes a portion of the resistive layer. The touch sensor further includes a plurality of electrically conductive segments that are disposed on the insulative layer. Each conductive segment makes electrical contact with the resistive layer through at least one of the open areas in the insulative layer. The conductive segments improve linearity of the touch sensitive area.

In another embodiment of the invention, a touch sensor includes an electrically resistive layer that defines a touch sensitive area. The touch sensor further includes an electrically insulative layer that is disposed on the electrically resistive layer. The touch sensor further includes a field linearization pattern that is disposed on the insulative layer. The linearization pattern improves linearity of the touch sensitive area by making electrical contact with the resistive layer through one or more openings in the insulative layer.

In another embodiment of the invention, a touch sensor includes an electrically resistive layer that covers a touch sensitive area. The touch sensor further includes an electrically insulative layer that is disposed on the resistive layer. The touch sensor further includes an electrically conductive linearization pattern that is disposed on the insulative layer. The linearization pattern makes electrical contact with the resistive layer through the insulative layer at a plurality of random locations on the insulative layer. The linearization pattern improves linearity of the touch sensitive area.

In another embodiment of the invention, a method for making a touch sensor includes the steps of: providing an electrically resistive layer that covers a touch sensitive area; providing an electrically insulative layer on the electrically resistive layer, where the insulative layer has one or more open areas that expose the electrically resistive layer; and providing electrical contact between a field linearization pattern and the electrically resistive layer through at least some of the open areas in the insulative area, where the field linearization pattern improves linearity of the touch sensitive area.

### BRIEF DESCRIPTION OF DRAWINGS

The invention may be more completely understood and appreciated in consideration of the following detailed description of various embodiments of the invention in connection with the accompanying drawings, in which:

FIG. 1 illustrates a schematic side-view of a touch sensor in accordance with one embodiment of the invention;

FIG. 2 is a flow chart indicating steps that can be performed in some methods of the present invention; and

FIG. 3 is a schematic side-view of an optical system in accordance with another embodiment of the invention.

### DETAILED DESCRIPTION

The present disclosure describes a capacitive touch sensor where a resistive film in the touch sensitive area is covered with a dielectric layer having a plurality of open areas that expose the resistive film, and where a linearization pattern for linearizing an electric field in the touch sensitive area is disposed on the dielectric layer and makes electric contact with the resistive film through the openings in the dielectric layer.

One advantage of the present invention is that the resistive film is protected by the dielectric layer during further processing including the steps of disposing and patterning the linearization pattern. According to the present invention, the dielectric layer is sufficiently thick and provides sufficient surface coverage of the resistive film to protect the resistive film against damage during processing and use while having sufficient openings to allow adequate electrical contact between the linearization pattern and the resistive film so that the touch sensitive area is sufficiently linearized for a given application.

Another advantage of the present invention is that the dielectric layer can be applied at the same time or in the same location as the resistive film, for example, in the same sputtering chamber or the same coating facility, with the electrodes applied in a later step.

The present invention may also be advantageous in circumstances where the formation of the resistive layer is part of a float glass manufacturing process where a resistive layer and other layers such as a hard coat layer and/or an antiglare layer are applied to a float glass in a float bath at elevated temperatures, such as 500° C. or higher. In such a case, the present invention can allow application of, for example, an antiglare layer to the resistive layer prior to the formation of a linearization pattern, thereby reducing cost and allowing more flexibility in manufacturing of a touch sensor.

Furthermore, the present invention can eliminate or reduce the need for high temperature processing to allow a conductive frit to locally dissolve, burn, or etch through a dielectric layer to make electric contact with a resistive film by providing a porous dielectric layer where the pores allow the electric contact to be made at much lower processing temperatures including room temperature. Low temperature processing is particularly desirable where, for example, the resistive film and/or the substrate on which the resistive film is disposed is polymeric.

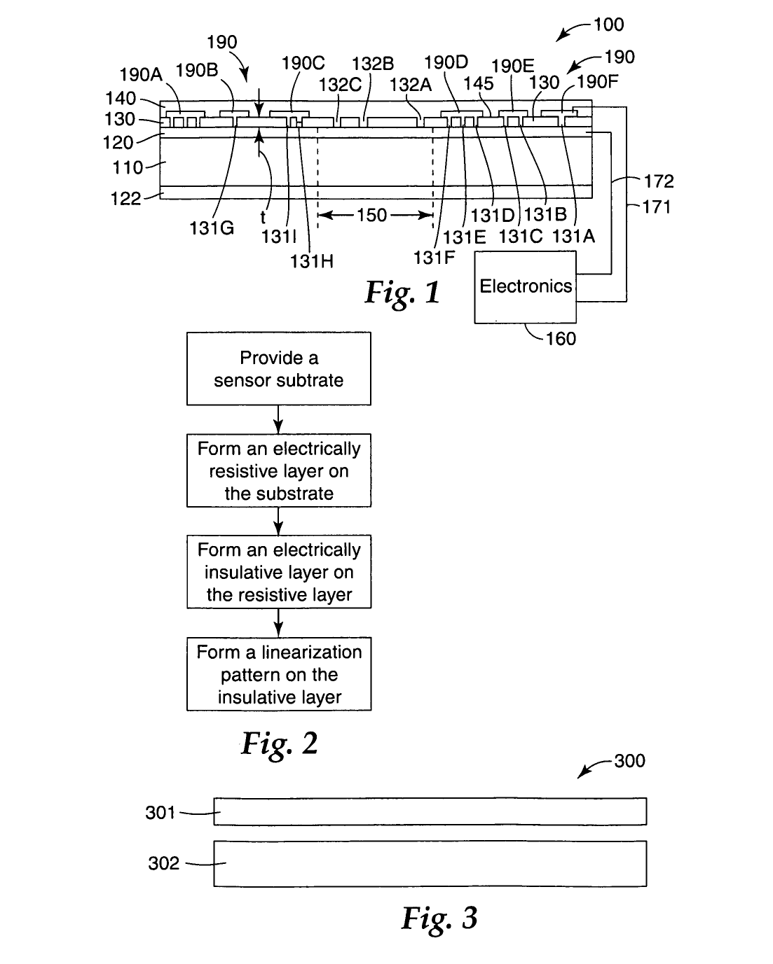

FIG. 1 is a schematic side-view of a capacitive touch sensor 100 in accordance with one embodiment of the invention. Touch sensor 100 includes a substrate 110, an electrically resistive layer 120 disposed on substrate 110, and an electrically insulative layer 130 disposed on electrically resistive layer 120. Electrically insulative layer 130 has one or more open areas, such as open areas 131A-131G outside a touch sensitive area 150 and open areas 132A-132C within touch sensitive area 150. Each open area extends a local thickness, t, of insulative layer 130 exposing electrically resistive layer 120 where the local thickness can be different at different points on insulative layer 130. Touch sensor 100 further includes a linearization pattern 190 that is disposed on electrically insulative layer 130 and makes electrical contact with resistive layer 120 through some of the openings in insulative layer 130. In the exemplary embodiment shown in FIG. 1, linearization pattern 190 has electrically conductive segments 190A-190F which make electrical contact with resistive layer 120 through some of the openings in insulative layer 130. For example, electrically conductive segment 190B makes electrical contact with resistive layer 120 through opening 131G, electrically conductive segment 190D makes electrical contact with resistive layer 120 through openings 131D-131F, and electrically conductive segment 190E makes electrical contact with resistive layer 120 through openings 131B and 131C.

The open areas in insulative layer 130 may be randomly distributed throughout insulative layer 130. In this case, linearization pattern 190 makes electrical contact with electrically resistive layer 120 at a plurality of random locations, each random location corresponding to an open area in insulative layer 130.

Insulative layer 130 can be continuous. Insulative layer 130 can be discontinuous. For example, insulative layer 130 can be made of a plurality of discrete islands where each island is made of an electrically insulative material, and where the islands are separated from each other by open areas.

Linearization pattern 190 need not make electrical contact with electrically resistive layer 120 through every opening in insulative layer that is covered by the linearization pattern. For example, conductive segment 190C covers open areas 131H and 1311 in insulative layer 130 and make electrical contact with resistive layer 120 through opening 131I, but not through opening 131H. According to one embodiment of the invention, there is sufficient electric contact between linearization pattern 190 and electrically resistive layer 120 through sufficient number of openings in insulative layer 130 so that linearization pattern 190 improves the linearity of touch sensitive area 150 to an acceptable level in a given application.

As used herein, field linearity is defined in terms of the departure of the field from a linear electric field. Field linearity can further be defined in terms of linearity and spacing uniformity of equipotential lines, especially near the linearization pattern. The electric field in touch sensitive area 150 is preferably linearized to within 10%, more preferably to within 5%, more preferably to within 2%, even more preferably to within 1%, even more preferably to within 0.5%, and even more preferably to within 0.25%.

Electrically resistive layer 120 can be optically opaque, or partially or substantially transmissive of visible light. Electrically resistive layer 120 can be a metal, semiconductor, doped semiconductor, semi-metal, metal oxide, an organic conductor, a conductive polymer, and the like. Exemplary metal conductors include gold, copper, silver, and the like. Exemplary inorganic materials include transparent conductive oxides, for example indium tin oxide (ITO), fluorine doped tin oxide, tin antimony oxide (TAO), and the like. Exemplary organic materials include conductive polymers such as polypyrrole, polyaniline, polyacetylene, and polythiophene, such as those disclosed in European Patent Publication EP-1-172-831-A2. The sheet resistance of resistive layer 120 can be in a range of about 50 to 100,000 Ohms/square. The sheet resistance of the conductive film 120 is preferably in a range of about 100 to 50,000 Ohms/square, more preferably in a range of about 200 to 10,000 Ohms/Square, and even more preferably in a range of about 500 to 4,000 Ohms/Square.

Substrate 110 can be glass, plastic, or any other suitable sensor substrate. In addition, the substrate can be a functioning device such as an electronic display, a privacy filter, a polarizer, and so forth.

Electrically insulative layer 130 can have a matte surface 145 for providing antiglare properties in touch sensitive area 150. Insulative layer 130 can be made of any material that is sufficiently electrically insulative in a given application. Examples include silicon oxide, silicon dioxide, silicon nitride, silica sol-gels, silica using alkoxides such as tetra ethyl ortho silicate TEOS, tetra ethyl boatrate, tetra methyl oxy fosrate (disclosed in, for example, U.S. Pat. Nos. 6,358,766; 6,818,921; and 6,844,249), and the like.

Insulative layer 130 can be applied to resistive layer 120 by wet-chemical deposition, spin coating, dipping, transfer coating, spraying, screen-printing, vacuum deposition, chemical vapor deposition, roll coating, photolithography, dispensing, or stamping, some of which are disclosed, for example, in U.S. Pat. Nos. 5,725,957; 6,001,486; 6,087,012; 6,373,618; 6,440,491; 6,488,981; 6,795,226; or by other suitable coating techniques.

The open areas in insulative layer 130 may be formed during formation of the insulative layer by, for example, spray coating. The open areas may be formed, at least in part, due to the material composition of the insulative layer. For example, the material composition of the insulative layer may include inorganic components dispersed in an organic binder, where the organic binder is burned away subsequent to forming the insulative layer resulting in open areas in the layer. The open areas may by formed by other means such as photolithography, sputtering, ablation such as laser ablation, selective etching, reactive ion etching, or any other suitable method for forming openings in insulative layer 130.

Touch sensor 100 further includes an optional electrically insulative layer 140 disposed on linearization pattern 190 to, for example, protect the linearization pattern against damage during further processing. In FIG. 1, electrically insulative layer 140 covers touch sensitive area 150. In some applications, insulative layer 140 may only be disposed in a border area, for example, where linearization pattern 190 resides. Insulative layer 140 can, for example, provide durability, resistance to abrasion, or antiglare properties.

Touch sensor 100 further includes electronics 160 electrically connected to appropriate locations in the touch sensor through exemplary electrically conductive leads 171 and 172. Electronics 160 is configured to detect a signal induced by a touch implement applied to touch sensitive area 150. The signal detected by the electronics can be used to determine the touch location. For example, the characteristics of the detected signal, such as magnitude and phase, can be such that the electronics can distinguish the detected signal from any background noise or undesired signal, thereby resulting in a sufficiently large signal to noise ratio to determine the touch location.

According to one embodiment of the invention, touch sensor 100 is a capacitive touch sensor. In some applications, touch sensor 100 can be part of a resistive touch sensor by, for example, replacing insulative layer 140 with an electrically resistive layer.

Linearization pattern 190 can be any pattern that can improve linearity in touch sensitive area 150, such as those disclosed in U.S. Pat. Nos. 4,293,734; 4,353,552; 4,371,746; 4,622,437; 4,731,508; 4,797,514; 5,045,644; 6,549,193; and 6,593,916.

Linearization pattern 190 can be made of materials that include a metal such as silver, gold, copper, aluminum, lead, and the like, or a combination of metals. Linearization pattern 190 can be made of materials that include carbon or other additives to make the pattern conductive or more conductive. Linearization pattern 190 can be deposited onto insulative layer 130 using ink jet printing, screen printing, or any other suitable method for depositing the linearization pattern onto insulative layer 130. Linearization pattern 190 can be patterned using photolithography, ink jet printing, or any other suitable patterning method.

Touch sensor 100 may have other optional layers such as optional layer 122 for providing an electric shield and/or anti-glare properties. Touch sensor 100 may have other layers and films not explicitly shown in FIG. 1, such as light control films, polarizers, and any other film that may be desirable in a given application.

FIG. 2 shows a flow chart indicating steps that can be performed to make a touch sensor according to one embodiment of the invention. For example, a touch sensor substrate can be provided. The substrate can be glass, plastic, or any other suitable sensor substrate. Next, an electrically resistive layer can be formed (or otherwise provided) on the substrate. The resistive layer preferably has electrical properties such as sheet resistance and uniformity that are desirable in a given touch sensing application. An electrically insulative layer that has openings can then be formed on the electrically resistive layer. The electrically insulative layer can cover the entire resistive layer or can be patterned to cover certain portions of the resistive layer such as the periphery. The openings can be one or more openings in an otherwise continuous layer. Alternatively, the electrically insulative layer can be made of a plurality of discrete islands where each island is made of an electrically insulative material, and where the areas between the islands provide the open areas in the electrically insulative layer. The openings can be arranged in a regular pattern or be distributed randomly across the insulative layer. Next, a linearization pattern is formed on the electrically insulative layer making electrical contact with the electrically resistive layer through at least some of the openings in the electrically insulative layer.

FIG. 3 illustrates a schematic cross-section of a display system 300 in accordance with one embodiment of the present invention. Display system 300 includes a touch sensor 301 and a display 302. Display 302 can be viewable through touch sensor 301. Touch sensor 301 can be a touch sensor according to any embodiment of the present invention. Display 302 can include permanent or replaceable graphics (for example, pictures, maps, icons, and the like) as well as electronic displays such as liquid crystal displays (LCD), cathode ray tubes (CRT), plasma displays, electroluminescent displays, OLEDs, electrophoretic displays, and the like. It will be appreciated that although in FIG. 3 display 302 and touch sensor 301 are shown as two separate components, the two can be integrated into a single unit. For example, touch sensor 301 can be laminated to display 302. Alternatively, touch sensor 301 can be an integral part of display 302.

Advantages and embodiments of the present invention are further illustrated by the following example. The particular materials, amounts and dimensions recited in this example, as well as other conditions and details, should not be construed to unduly limit the present invention. A capacitive touch sensor according to one embodiment of the present invention was assembled as follows.

A 3 mm thick rectangular (12″×16″) flat soda lime glass substrate was coated with a doped tin-oxide transparent conductive layer. The sheet resistance of the conductive layer was about 1500 ohms per square.

Next, the conductive layer was spray coated with a silica-based solution available from Optera, Inc., Holland, Mich. The coating resulted in a discontinuous silica layer that acted as an antiglare coating. The silica layer covered approximately 50% of the conductive layer surface and had an average surface roughness of 0.1 microns. The discontinuous features in the silica layer had an average size of approximately 100 square microns. The mean and maximum heights of the discontinuous features were 0.15 and 0.5 microns, respectively.

Next, a linearization pattern similar to the pattern disclosed in U.S. Pat. No. 4,293,734 was formed on the discontinuous silica layer by screen printing a silver paste (DuPont 7713 silver conductive frit available commercially from E. I. DuPont Co., Wilmington, Del.) around the perimeter of the glass substrate. The coated assembly was subsequently heated at about 500° C. for about 8 minutes. The linearization pattern included four rows of conductive segments. Each segment in the three interior rows was 0.03 inches wide. The segments in the outermost row were 0.04 inches wide. The separation between adjacent rows was 0.13 inches resulting in an overall pattern width of 0.5 inches and a touch sensitive active area of about 11″ by 15″ within the linearization pattern.

The accuracy of the active area was determined by contacting the active area at 25 points forming a 5×5 grid pattern that essentially covered the entire active region. The maximum deviation from the true positions among the 25 contact points was measured at 1.4% of the diagonal dimension of the active area.

All patents, patent applications, and other publications cited above are incorporated by reference into this document as if reproduced in full. While specific examples of the invention are described in detail above to facilitate explanation of various aspects of the invention, it should be understood that the intention is not to limit the invention to the specifics of the examples. Rather, the intention is to cover all modifications, embodiments, and alternatives falling within the spirit and scope of the invention as defined by the appended claims.

What is claimed is:

1. A touch sensor comprising:
an electrically resistive layer covering a touch sensitive area;
an electrically insulative layer disposed on the electrically resistive layer, the insulative layer having open areas, each of the open areas exposing a portion of the resistive layer; and
a plurality of electrically conductive segments disposed on the insulative layer, each of the conductive segments making electrical contact with the resistive layer through at least one of the open areas in the insulative layer, wherein the plurality of electrically conductive segments improves linearity of the touch sensitive area.

2. The touch sensor of claim 1, wherein the electrically resistive layer comprises a conductive polymer.

3. The touch sensor of claim 1, wherein the electrically insulative layer is a continuous layer.

4. The touch sensor of claim 1, wherein the electrically insulative layer is a discontinuous layer.

5. The touch sensor of claim 1, wherein the electrically insulative layer is a porous layer.

6. The touch sensor of claim 1, wherein a total area of the one or more open areas is no less than 20% of a total area of the electrically insulative layer.

7. The touch sensor of claim 1, wherein a total area of the one or more open areas is no less than 50% of a total area of the electrically insulative layer.

8. The touch sensor of claim 1, each of the conductive segments makes electrical contact with the resistive layer only through the one or more open areas in the insulative layer.

9. The touch sensor of claim 1, wherein an electric field in the touch sensitive area is linearized to within 10%.

10. The touch sensor of claim 1, wherein an electric field in the touch sensitive area is linearized to within 5%.

11. The touch sensor of claim 1, wherein an electric field in the touch sensitive area is linearized to within 2%.

12. The touch sensor of claim 1, wherein an electric field in the touch sensitive area is linearized to within 1%.

13. The touch sensor of claim 1, wherein an electric field in the touch sensitive area is linearized to within 0.5%.

14. The touch sensor of claim 1 being a capacitive touch sensor.

15. The touch sensor of claim 1 being a resistive touch sensor.

16. A display system comprising the touch sensor of claim 1.

17. A touch sensor comprising:
an electrically resistive layer defining a touch sensitive area;
an electrically insulative layer disposed on the electrically resistive layer; and
a field linearization pattern disposed on the insulative layer and capable of improving a linearity of the touch sensitive area by making electrical contact with the resistive layer through one or more pre-existing openings in the insulative layer.

18. The touch sensor of claim 17, wherein the electrically insulative layer is a continuous layer.

19. The touch sensor of claim 17, wherein the electrically insulative layer is a discontinuous layer.

20. The touch sensor of claim 17, wherein the electrically insulative layer is a porous layer.

21. A touch sensor comprising:
an electrically resistive layer covering a touch sensitive area;
an electrically insulative layer disposed on the resistive layer; and
an electrically conductive linearization pattern disposed on the insulative layer, the linearization pattern making electrical contact with the resistive layer through the insulative layer at a plurality of random locations on the insulative layer, the linearization pattern improving a linearity of the touch sensitive area.

22. The touch sensor of claim 21, wherein each of the plurality of random locations is located at an open area in the insulative layer exposing a portion of the resistive layer.

23. A method for making a touch sensor comprising the steps of:
providing an electrically resistive layer covering a touch sensitive area;
providing an electrically insulative layer on the electrically resistive layer, the insulative layer having one or more open areas exposing the electrically resistive layer; and
providing electrical contact between a field linearization pattern and the electrically resistive layer through at least some of the one or more open areas in the insulative area, the field linearization pattern being configured to improve a linearity of the touch sensitive area.
